(19) United States
(12) Patent Application Publication
(10) Pub. No.: US 2020/0357284 A1
(43) Pub. Date: Nov. 12, 2020

(54) INFORMATION PROCESSING APPARATUS AND INFORMATION PROCESSING METHOD

(71) Applicant: Sony Corporation, Tokyo (JP)

(72) Inventors: Yasuhiro SUTOU, Kanagawa (JP); Toshio YAMAZAKI, Tokyo (JP); Kentaro DOBA, Tokyo (JP); Takuto MOTOYAMA, Tokyo (JP); Seungha YANG, Kanagawa (JP)

(73) Assignee: Sony Corporation, Tokyo (JP)

(21) Appl. No.: 16/770,086

(22) PCT Filed: Dec. 10, 2018
(86) PCT No.: PCT/JP2018/045369

§ 371 Date: Jun. 5, 2020

(30) Foreign Application Priority Data
Dec. 15, 2017 (JP) 2017-240146

(51) Int. Cl. G08G 1/16; B60W 60/00; B60W 40/02; H04W 4/40

(52) U.S. Cl. CPC G08G 1/166; B60W 60/0015; B60W 40/02; B60W 2554/4029; B60W 2556/45; B60W 2554/4041; H04W 4/40

(57) ABSTRACT

An object detection section detects an object that is present in surroundings. A transmission section broadcasts a request signal requesting information regarding an object that has not been detected by the object detection section. A reception section receives a response signal in response to transmission of the request signal, the response signal including the information regarding the object that has not been detected by the object detection section. For example, a display control section controls display of a surrounding environment on the basis of information regarding positions and attributes of a predetermined number of objects detected by the object detection section and controls update of the display of the surrounding environment on the basis of information regarding a position and an attribute of the object that is included in the response signal and that has not been detected by the object detection section.

### TECHNICAL FIELD

The present technology relates to an information processing apparatus and an information processing method, and particularly, to an information processing apparatus and an information processing method that increase the accuracy of recognizing objects that are present in the surroundings.

### BACKGROUND ART

For example, PTL 1 and the like describe a general automatic driving control system that recognizes objects such as vehicles and humans that are present in the surroundings of a vehicle and grasps a surrounding environment by using an external sensor such as a camera or a millimeter-wave radar to perform automatic driving control on the basis of the result.

### CITATION LIST

### Patent Literature

[PTL 1]

### SUMMARY

### Technical Problem

In the case of detecting objects such as vehicles and humans that are present in the surroundings of the vehicle by using the external sensor, there is a possibility that objects that are in a place with poor visibility, objects that are under the weather such as rain or fog, or the like fail to be recognized and the surrounding environment cannot be correctly grasped.

An object of the present technology is to increase the accuracy of recognizing objects that are present in the surroundings.

### Solution to Problem

A concept of the present technology lies in an information processing apparatus including: an object detection section configured to detect an object that is present in surroundings; a transmission section configured to broadcast a request signal requesting information regarding an object that has not been detected by the object detection section; and a reception section configured to receive a response signal in response to transmission of the request signal, the response signal including the information regarding the object that has not been detected by the object detection section.

In the present technology, the object detection section detects an object that is present in surroundings. For example, the object detection section includes an external sensor such as a camera or a radar attached to a vehicle. The transmission section broadcasts a request signal requesting information regarding an object that has not been detected by the object detection section. For example, the request signal may include information regarding a predetermined number of objects detected by the object detection section.

For example, the transmission section may broadcast the request signal in a driver caution area. Further, for example, the transmission section may broadcast the request signal in a place with poor visibility. Further, for example, the transmission section may broadcast the request signal in a case where there is a possibility that an object enters in a traveling direction.

As described above, in the present technology, a request signal requesting information regarding an object that has not been detected by the object detection section is broadcast, and a response signal including the information regarding the object is received. Therefore, the accuracy of recognizing objects that are present in the surroundings can be increased.

It is noted that in the present technology, for example, a display control section configured to control display of a surrounding environment on the basis of information regarding positions and attributes of a predetermined number of objects detected by the object detection section and control update of the display of the surrounding environment on the basis of information regarding a position and an attribute of the object that is included in the response signal and that has not been detected by the object detection section may be further included. Accordingly, the accuracy of displaying the surrounding environment can be increased.

Further, another concept of the present technology lies in an information processing apparatus including: a reception section configured to receive a request signal from external equipment, the request signal including information regarding positions and attributes of a predetermined number of objects that are present in surroundings of the external equipment; and a transmission section configured to, in a case where a predetermined object associated with the information processing apparatus is not included in the predetermined number of objects, unicast a response signal including information regarding a position and an attribute of the predetermined object to the external equipment.

In the present technology, a request signal is received by the reception section from external equipment, the request signal including information regarding positions and attributes of a predetermined number of objects that are present in surroundings of the external equipment. Then, in a case where a predetermined object associated with the information processing apparatus is not included in the predetermined number of objects, a response signal including information regarding a position and an attribute of the predetermined object is unicasted by the transmission section to the external equipment.

As described above, in the present technology, in a case where a predetermined object is not included in a predetermined number of objects that are present in surroundings of external equipment, a response signal including information regarding a position and an attribute of the predetermined object is unicast to the external equipment. Therefore, the accuracy of recognizing objects that are present in the surroundings can be increased in the external equipment.

### Advantageous Effects of Invention

According to the present technology, the accuracy of recognizing objects that are present in the surroundings can be increased. It is noted that the effects described in the present specification are merely examples and are not limited. Further, additional effects may be provided.

### BRIEF DESCRIPTION OF DRAWINGS

FIG. 1 is a diagram illustrating an example in which objects are present in the surroundings of a vehicle.

FIG. 2 is a diagram for describing a configuration of a request signal.

FIG. 3 is a block diagram illustrating an example of a schematic functional configuration of a vehicle control system to which the present technology is applied.

FIG. 4 is a flowchart illustrating an example of a processing procedure of the vehicle.

FIG. 5 is a flowchart illustrating an example of a processing procedure of a smartphone.

FIG. 6 is a diagram for describing an example of display of a real environment and a surrounding environment in a case where the vehicle enters an intersection.

### DESCRIPTION OF EMBODIMENT

Hereinafter, a mode for carrying out the invention (hereinafter referred to as “embodiment”) will be described. It is noted that the description will be made in the following order.

1. Embodiment

2. Modification

<1. Embodiment>

[Vehicle and Objects that are Present in the Surroundings of the Vehicle]

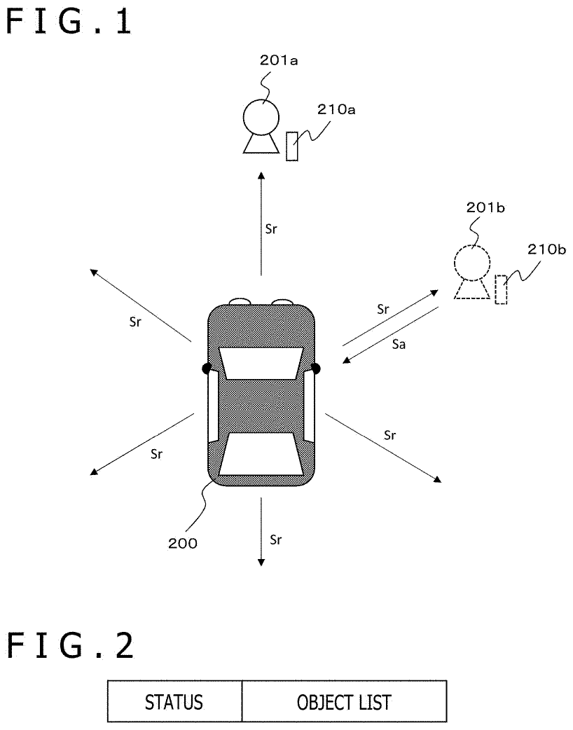

FIG. 1 illustrates an example in which objects 201a and 201b are present in the surroundings of a vehicle 200. It is noted that in this embodiment, a vehicle refers to an automobile. In the illustrated example, the objects 201a and 201b are both humans. However, objects that are present in the surroundings of the vehicle 200 are not limited to humans and may be bicycles, motorcycles, other vehicles, or the like. The objects 201a and 201b have smartphones 210a and 210b, respectively, which are mobile terminals.

Here, the smartphones 210a and 210b are associated with the objects 201a and 201b, respectively. That is, position information acquired by a GPS function of each of the smartphones 210a and 210b represents the position of each of the objects 201a and 201b, respectively. Further, a transmitter ID of each of the smartphones 210a and 210b also serves as an identification ID for identifying each of the objects 201a and 201b, respectively.

The vehicle 200 includes an object detection section, not illustrated, which uses an external sensor such as a stereo camera, a millimeter-wave radar using millimeter waves, or an LIDAR (Light Detection and Ranging) using a laser. The object detection section detects objects that are present in the surroundings. In the illustrated example, the object 201a is detected, but the object 201b is not detected.

There are various conceivable causes of why the object 201b is not detected. For example, the object 201b is in a place with poor visibility, the stereo camera, radar, or the like does not sufficiently function because it is raining, there is fog, or it is nighttime, or the like.

In this embodiment, the vehicle 200 automatically broadcasts a request signal (radio horn) Sr under a predetermined transmission condition. The request signal Sr requests information regarding an object that has not been detected by the object detection section. The predetermined condition includes, for example, a case where the vehicle 200 is in a driving caution area, a case where the vehicle 200 is in a place with poor visibility, a case where there is a possibility that an obstacle enters in a direction in which the vehicle 200 travels, and the like.

For example, the driving caution area includes intersections, T-intersections, and the like. The vehicle 200 can determine whether the vehicle 200 is in the driving caution area from GPS position information, map information, and the like. The driving caution area registered in advance in a car navigation system may be used as the driving caution area or the driving caution area may be arbitrarily set by the driver.

Further, for example, a place with poor visibility includes a place where it is raining, a place where there is fog, a place facing the sun, and the like. Further, the place with poor visibility includes a place with an obstacle blocking ahead, a place with a narrow road, a hairpin turn, a dark place, and the like. The vehicle 200 can determine whether it is raining or there is fog, whether there is an obstacle, whether the place is dark, or the like on the basis of a detection signal of the sensor. Further, the vehicle 200 can determine whether there is a hairpin turn from the GPS position information, the map information, and the like.

Further, a case where an obstacle suddenly enters in the traveling direction occurs at the time of overtaking, a left or right turn, acceleration, and the like. The vehicle 200 can determine these cases on the basis of the driver's steering operation, turn signal operation, accelerator operation, and the like.

It is noted that it is not necessary to broadcast the request signal Sr in all of these cases. A conceivable configuration is to broadcast the request signal Sr only in either selected cases or set cases. Further, it is also conceivable that the vehicle 200 broadcasts the request signal Sr in response to a manual operation by the driver, in addition to automatically broadcasting the request signal under the above-described predetermined condition.

The request signal Sr includes information regarding a predetermined number of objects detected by the object detection section. FIG. 2 illustrates an example of a configuration of the request signal. The request signal Sr includes a status section and an object list section following the status section. The status section includes a transmitter ID, which is a unique ID of the vehicle 200, information regarding the transmitter position and moving speed, a message ID indicating a message type, moreover, time information such as GPS time, and the like. In the case of the request signal, the message ID indicates the request signal.

Further, the object list section includes object information regarding each of a predetermined number of objects detected by the object detection section. The object information regarding each object includes position information, attribute information, speed information as an option, and the like. Here, the position information indicates the position of the corresponding object and is latitude, longitude, and altitude information in the GPS coordinate system, for example. Further, the attribute information indicates, for example, the type of the corresponding object such as a human, a car, a motorcycle, a bicycle, or unknown. The speed information indicates the moving speed of the corresponding object.

The smartphones 210a and 210b receive the request signal Sr broadcast from the vehicle 200. Each of the smartphones 210a and 210b determines whether object information regarding the corresponding object associated with the smartphone 210a or 210b is included in the object list section of the request signal, and, in a case where the object information regarding the corresponding object is not included, unicasts a response signal Sa including the object information regarding the object to the vehicle 200.

In the illustrated example, since the object 201a has already been detected by the object detection section of the vehicle 200, the object information regarding the object 201a is included in the object list section of the request signal Sr. Therefore, the smartphone 210a associated with the object 201a does not unicast the response signal Sa to the vehicle 100.

In the illustrated example, on the other hand, since the object 201b has not been detected by the object detection section of the vehicle, the object information regarding the object 201b is not included in the object list section of the request signal Sr. Therefore, the smartphone 210b associated with the object 201b unicasts the response signal Sa to the vehicle 100.

The response signal Sa also includes a status section and an object list section following the status section, as in the case of the request signal Sr described above (see FIG. 2). The status section includes a transmitter ID, which is a unique ID of the object 201b, a message ID indicating a message type, moreover, time information such as GPS time, and the like. In the case of the response signal, the message ID indicates the response signal. The object list section further includes the object information regarding the object 101b, in addition to the object information included in the request signal. It is noted that only the object information regarding the object 201b may be included.

The vehicle 200 not only recognizes the presence of a predetermined number of objects detected by the object detection section, but also recognizes an object that has not been detected by the object detection section on the basis of the response signal Sa. In the illustrated example, the vehicle 200 recognizes the object 201a by the object detection section detecting the object 201a, and recognizes the object 201b from the response signal Sa transmitted in response to the broadcast request signal Sr. In this manner, the vehicle 200 increases the accuracy of recognizing objects that are present in the surroundings.

On the basis of the information regarding the positions and attributes of the predetermined number of objects detected by the object detection section, the vehicle 200 displays a surrounding environment including the display of these detected objects on a display section, for example, a display panel of the car navigation system or a head-up display (HUD). On the basis of the information regarding the object included in the response signal Sa, moreover, the vehicle 200 updates the display of the surrounding environment so as to include the display of the object. Accordingly, the driver can drive with correct recognition of the surrounding environment.

It is noted that it is also conceivable that the vehicle 200 automatically performs driving control on the basis of the information regarding the object included in the response signal Sa. For example, in a case where the vehicle 200 recognizes that the object is present in the direction in which the vehicle 200 travels, the vehicle 200 may perform control such as deceleration or stop, sounding a horn, or the like.

Further, for example, it is also conceivable to unicast a caution signal to the smartphone associated with the object in the direction in which the vehicle 200 travels. For example, the caution signal includes information regarding the level of risk. In this case, it is conceivable that the smartphone displays the caution on the display screen or calls for caution with sound or vibration. For example, in a case where the risk is low, the smartphone gives notification with vibration and a beep sound, while in a case where the risk is high, the smartphone gives notification of vehicle approaching with display (e.g., display of “vehicle approaching” or the like) and sound.

It is noted that it is also conceivable that when the smartphone receives the request signal Sr from the vehicle 200, the smartphone itself determines the level of the risk, such as short time-to-collision, on the basis of information regarding the transmitter position and moving speed included in the status section of the request signal Sr. For example, it is conceivable that in a case where the risk is low, the smartphone gives notification with vibration and a beep sound, while in a case where the risk is high, the smartphone gives notification of vehicle approaching with display (e.g., display of “vehicle approaching” or the like) and sound. Further, in a case where the smartphone determines that there is almost no risk, the smartphone can simply display information that the request signal Sr has been received in a notification field.

Communication between the vehicle 200 and the smartphones 210a and 210b is performed using communication between a vehicle and a pedestrian (V2P), for example. It is noted that in a case where an object in the surroundings is a vehicle, communication is performed using communication between a vehicle and a vehicle (V2V). It is noted that communication between the vehicle 100 and an object that is present in the surroundings of the vehicle 100 is not limited to V2X communication and it is also conceivable that the communication is performed using another communication.

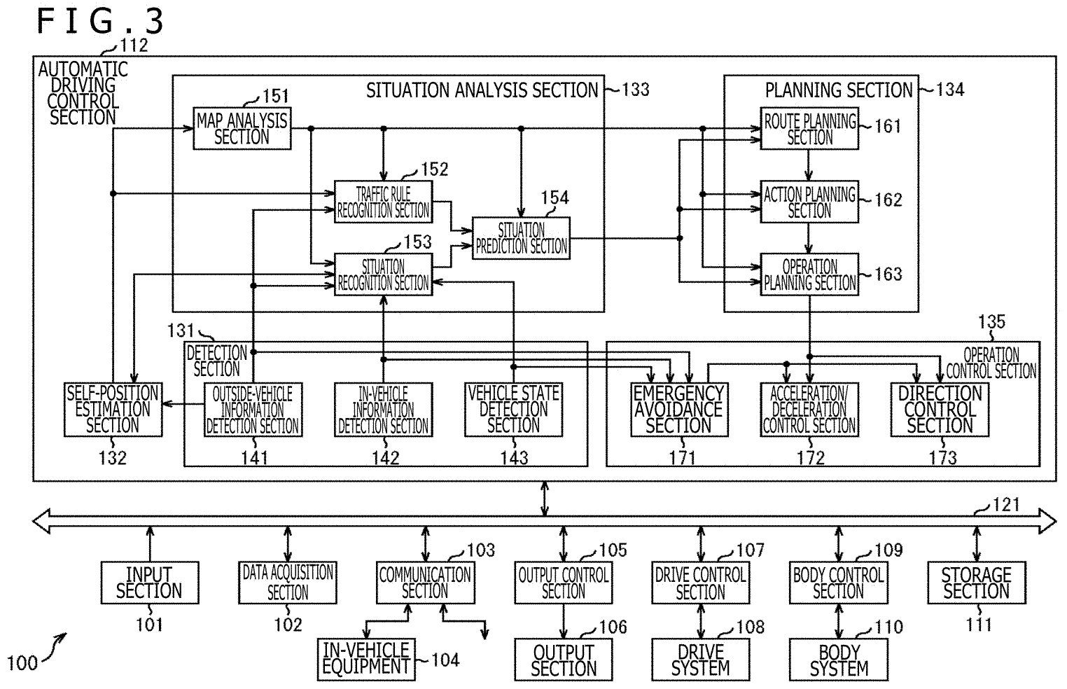

FIG. 3 is a block diagram illustrating an example of a schematic functional configuration of a vehicle control system 100 to which the present technology is applied.

It is noted that hereinafter, in a case where a vehicle including the vehicle control system 100 is distinguished from other vehicles, the vehicle will be referred to as a host car or a host vehicle.

The vehicle control system 100 includes an input section 101, a data acquisition section 102, a communication section 103, in-vehicle equipment 104, an output control section 105, an output section 106, a drive control section 107, a drive system 108, a body control section 109, a body system 110, a storage section 111, and an automatic driving control section 112. The input section 101, the data acquisition section 102, the communication section 103, the output control section 105, the drive control section 107, the body control section 109, the storage section 111, and the automatic driving control section 112 are interconnected through a communication network 121. For example, the communication network 121 includes a vehicle-mounted communication network, a bus, and the like that conform to an arbitrary standard such as a CAN (Controller Area Network), a LIN (Local Interconnect Network), a LAN (Local Area Network), or FlexRay (registered trademark). It is noted that each section of the vehicle control system 100 may be, in some cases, directly connected without the communication network 121.

It is noted that hereinafter, in a case where each section of the vehicle control system 100 performs communication through the communication network 121, the description of the communication network 121 will be omitted. For example, in a case where the input section 101 and the automatic driving control section 112 communicate with each other through the communication network 121, it will be simply described that the input section 101 and the automatic driving control section 112 communicate with each other.

The input section 101 includes apparatuses that are used by an occupant to input various types of data, instructions, and the like. For example, the input section 101 includes operation devices such as a touch panel, a button, a microphone, a switch, and a lever, an operation device that can be input by a method other than a manual operation, such as voice or gesture, and the like. Further, for example, the input section 101 may be a remote control apparatus using infrared rays or other radio waves, or may be external connection equipment such as mobile equipment or wearable equipment that supports the operation of the vehicle control system 100. The input section 101 generates an input signal on the basis of data, instructions, and the like input by an occupant, and supplies the input signal to each section of the vehicle control system 100.

The data acquisition section 102 includes various types of sensors and the like that acquire data to be used for processing in the vehicle control system 100, and supplies the acquired data to each section of the vehicle control system 100.

For example, the data acquisition section 102 includes various types of sensors for detecting the state and the like of the host car. Specifically, the data acquisition section 102 includes, for example, a gyro sensor, an acceleration sensor, an inertial measurement unit (IMU), and a sensor for detecting the amount of operation of an accelerator pedal, the amount of operation of a brake pedal, the steering angle of a steering wheel, engine speed, motor speed, the rotational speed of wheels, or the like.

Further, for example, the data acquisition section 102 includes various types of sensors for detecting information regarding the outside of the host car. Specifically, the data acquisition section 102 includes, for example, imaging apparatuses such as a ToF (Time Of Flight) camera, a stereo camera, a monocular camera, an infrared camera, and other cameras. Further, the data acquisition section 102 includes, for example, an environment sensor for detecting weather, meteorological phenomenon, or the like, and a surrounding information detection sensor for detecting objects in the surroundings of the host car. The environment sensor includes, for example, a raindrop sensor, a fog sensor, a sunshine sensor, a snow sensor, and the like. The surrounding information detection sensor includes, for example, an ultrasonic sensor, a radar, LiDAR (Light Detection and Ranging, Laser Imaging Detection and Ranging), a sonar, and the like.

Moreover, for example, the data acquisition section 102 includes various types of sensors for detecting the current position of the host car. Specifically, the data acquisition section 102 includes, for example, a GNSS (Global Navigation Satellite System) receiver and the like. The GNSS receiver receives a GNSS signal from a GNSS satellite.

Further, for example, the data acquisition section 102 includes various types of sensors for detecting in-vehicle information. Specifically, the data acquisition section 102 includes, for example, an imaging apparatus that captures an image of the driver, a biosensor that detects biological information regarding the driver, a microphone that collects sound in the vehicle interior, and the like. For example, the biosensor is provided in a seat surface, the steering wheel, or the like and detects biological information regarding an occupant sitting on a seat or the driver holding the steering wheel.

The communication section 103 communicates with the in-vehicle equipment 104, various types of outside-vehicle equipment, a server, a base station, and the like to transmit data supplied from each section of the vehicle control system 100 and supply received data to each section of the vehicle control system 100. It is noted that there is no particular limitation to a communication protocol supported by the communication section 103 and the communication section 103 can support a plurality of types of communication protocols.

For example, the communication section 103 performs wireless communication with the in-vehicle equipment 104 using a wireless LAN, Bluetooth (registered trademark), NFC (Near Field Communication), WUSB (Wireless USB), or the like. Further, for example, the communication section 103 performs wired communication with the in-vehicle equipment 104 using a USB (Universal Serial Bus), an HDMI (High-Definition Multimedia Interface), an MHL (Mobile High-definition Link), or the like through a connection terminal, not illustrated, (and a cable if necessary).

Moreover, for example, the communication section 103 communicates with equipment (e.g., an application server or a control server) that is present on an external network (e.g., the Internet, a cloud network, or an operator-specific network) through a base station or an access point. Further, for example, the communication section 103 communicates with a terminal (e.g., a terminal of a pedestrian or a store, or an MTC (Machine Type Communication) terminal) that is present in the vicinity of the host car using a P2P (Peer To Peer) technology. Moreover, for example, the communication section 103 performs V2X communication such as communication between a vehicle and a vehicle (Vehicle to Vehicle), communication between a vehicle and infrastructure (Vehicle to Infrastructure), communication between the host car and a home (Vehicle to Home), and communication between a vehicle and a pedestrian (Vehicle to Pedestrian). Further, for example, the communication section 103 includes a beacon reception section to receive radio waves or electromagnetic waves transmitted from a wireless station or the like installed on a road and acquire information regarding the current position, traffic congestion, traffic regulation, necessary time, or the like.

The in-vehicle equipment 104 includes, for example, mobile equipment or wearable equipment owned by an occupant, information equipment carried into or attached to the host car, a navigation apparatus, which searches for a route to an arbitrary destination, and the like.

The output control section 105 controls the output of various types of information to an occupant or the outside of the host car. For example, the output control section 105 generates an output signal including at least one of visual information (e.g., image data) or auditory information (e.g., sound data) and supplies the output signal to the output section 106 to control the output of the visual information and the auditory information performed by the output section 106. Specifically, for example, the output control section 105 combines image data captured by different imaging apparatuses of the data acquisition section 102 to generate a bird's-eye view image, a panoramic image, or the like, and supplies an output signal including the generated image to the output section 106. Further, for example, the output control section 105 generates sound data including a warning sound, a warning message, or the like for danger such as collision, contact, or entry into a dangerous zone, and supplies an output signal including the generated sound data to the output section 106.

The output section 106 includes apparatuses capable of outputting the visual information or the auditory information to an occupant or the outside of the host car. The output section 106 includes, for example, a display apparatus, an instrument panel, an audio speaker, headphones, a wearable device such as an eyeglass-type display worn by an occupant, a projector, a lamp, and the like. The display apparatus included in the output section 106 may not only be an apparatus with a general display, but also be an apparatus that displays the visual information in the driver's field of view, such as a head-up display, a transmissive display, or an apparatus with an AR (Augmented Reality) display function, for example.

The drive control section 107 controls the drive system 108 by generating various types of control signals and supplying the control signals to the drive system 108. Further, the drive control section 107 supplies the control signals to each section other than the drive system 108 as necessary to notify each section of the control state of the drive system 108, for example.

The drive system 108 includes various types of apparatuses related to a drive system of the host car. The drive system 108 includes, for example, a drive force generation apparatus, a drive force transmission mechanism, a steering mechanism, a braking apparatus, an ABS (Antilock Brake System), an ESC (Electronic Stability Control), an electric power steering apparatus, and the like. The drive force generation apparatus generates drive force of an internal combustion engine, a drive motor, or the like. The drive force transmission mechanism transmits the drive force to the wheels. The steering mechanism adjusts the steering angle. The braking apparatus generates braking force.

The body control section 109 controls the body system 110 by generating various types of control signals and supplying the control signals to the body system 110. Further, the body control section 109 supplies the control signals to each section other than the body system 110 as necessary to notify each section of the control state of the body system 110, for example.

The body system 110 includes various types of apparatuses of a body system mounted in the vehicle body. For example, the body system 110 includes a keyless entry system, a smart key system, a power window apparatus, a power seat, the steering wheel, an air conditioning apparatus, various types of lamps (e.g., head lamps, back lamps, brake lamps, turn signals, fog lamps, and the like), and the like.

The storage section 111 includes, for example, a ROM (Read Only Memory), a RAM (Random Access Memory), a magnetic storage device such as an HDD (Hard Disc Drive), a semiconductor storage device, an optical storage device, a magneto-optical storage device, and the like. The storage section 111 stores various types of programs, data, and the like used by each section of the vehicle control system 100. For example, the storage section 111 stores map data such as a three-dimensional high-accuracy map such as a dynamic map, a global map that is less accurate than the high-accuracy map and covers a wide area, and a local map that includes information regarding the surroundings of the host car.

The automatic driving control section 112 performs control related to automatic driving such as autonomous travel or driving support. Specifically, for example, the automatic driving control section 112 performs cooperative control intended to implement ADAS (Advanced Driver Assistance System) functions that include collision avoidance or shock mitigation for the host car, following travel based on a following distance, vehicle speed maintaining travel, a warning of collision of the host car, a warning of deviation of the host car from a lane, or the like. Further, for example, the automatic driving control section 112 performs cooperative control intended for automatic driving or the like. The automatic driving allows autonomous travel without depending on the operation of the driver. The automatic driving control section 112 includes a detection section 131, a self-position estimation section 132, a situation analysis section 133, a planning section 134, and an operation control section 135.

The detection section 131 detects various types of information necessary to control automatic driving. The detection section 131 includes an outside-vehicle information detection section 141, an in-vehicle information detection section 142, and a vehicle state detection section 143.

The outside-vehicle information detection section 141 performs processes of detecting information regarding the outside the host car on the basis of data or signals from each section of the vehicle control system 100. For example, the outside-vehicle information detection section 141 performs processes of detecting, recognizing, and tracking objects in the surroundings of the host car and a process of detecting the distances to the objects. The objects to be detected include, for example, vehicles, humans, obstacles, structures, roads, traffic lights, traffic signs, road markings, and the like. Further, for example, the outside-vehicle information detection section 141 performs a process of detecting an environment in the surroundings of the host car. The surrounding environment to be detected includes, for example, weather, temperature, humidity, brightness, road surface conditions, and the like. The outside-vehicle information detection section 141 supplies data indicating the detection process result to the self-position estimation section 132, a map analysis section 151, a traffic rule recognition section 152, and a situation recognition section 153 of the situation analysis section 133, an emergency avoidance section 171 of the operation control section 135, and the like.

The in-vehicle information detection section 142 performs processes of detecting in-vehicle information on the basis of data or signals from each section of the vehicle control system 100. For example, the in-vehicle information detection section 142 performs processes of authenticating and recognizing the driver, a process of detecting the state of the driver, a process of detecting an occupant, a process of detecting an in-vehicle environment, and the like. The state of the driver to be detected includes, for example, physical conditions, the arousal level, the concentration level, the fatigue level, the gaze direction, and the like. The in-vehicle environment to be detected includes, for example, temperature, humidity, brightness, odor, and the like. The in-vehicle information detection section 142 supplies data indicating the detection process result to the situation recognition section 153 of the situation analysis section 133, the emergency avoidance section 171 of the operation control section 135, and the like.

The vehicle state detection section 143 performs a process of detecting the state of the host car on the basis of data or signals from each section of the vehicle control system 100. The state of the host car to be detected includes, for example, speed, acceleration, steering angle, presence/absence and contents of abnormality, the state of driving operation, the position and inclination of the power seat, the state of a door lock, the state of other vehicle-mounted equipment, and the like. The vehicle state detection section 143 supplies data indicating the detection process result to the situation recognition section 153 of the situation analysis section 133, the emergency avoidance section 171 of the operation control section 135, and the like.

The self-position estimation section 132 performs a process of estimating the position, attitude, and the like of the host car on the basis of data or signals from each section of the vehicle control system 100 such as the outside-vehicle information detection section 141 and the situation recognition section 153 of the situation analysis section 133. Further, the self-position estimation section 132 generates a local map (hereinafter referred to as a self-position estimation map) that is used to estimate the self position, as necessary. For example, the self-position estimation map is a high-accuracy map using a technique such as SLAM (Simultaneous Localization and Mapping). The self-position estimation section 132 supplies data indicating the estimation process result to the map analysis section 151, the traffic rule recognition section 152, and the situation recognition section 153 of the situation analysis section 133, and the like. Further, the self-position estimation section 132 causes the storage section 111 to store the self-position estimation map.

The situation analysis section 133 performs a process of analyzing the situations of the host car and the surroundings. The situation analysis section 133 includes the map analysis section 151, the traffic rule recognition section 152, the situation recognition section 153, and a situation prediction section 154.

The map analysis section 151 performs a process of analyzing various types of maps stored in the storage section 111 by using, as necessary, data or signals from each section of the vehicle control system 100 such as the self-position estimation section 132 and the outside-vehicle information detection section 141 and creates a map including information necessary for processes of automatic driving. The map analysis section 151 supplies the created map to the traffic rule recognition section 152, the situation recognition section 153, the situation prediction section 154, a route planning section 161, an action planning section 162, and an operation planning section 163 of the planning section 134, and the like.

The traffic rule recognition section 152 performs a process of recognizing traffic rules in the surroundings of the host car on the basis of data or signals from each section of the vehicle control system 100 such as the self-position estimation section 132, the outside-vehicle information detection section 141, and the map analysis section 151. Through this recognition process, the position and state of a traffic light in the surroundings of the host car, contents of traffic regulations in the surroundings of the host car, a travelable lane, and the like are recognized, for example. The traffic rule recognition section 152 supplies data indicating the recognition process result to the situation prediction section 154 and the like.

The situation recognition section 153 performs a process of recognizing the situation related to the host car on the basis of data or signals from each section of the vehicle control system 100 such as the self-position estimation section 132, the outside-vehicle information detection section 141, the in-vehicle information detection section 142, the vehicle state detection section 143, and the map analysis section 151. For example, the situation recognition section 153 performs a process of recognizing the situation of the host car, the situation in the surroundings of the host car, the situation of the driver of the host car, and the like. Further, the situation recognition section 153 generates a local map (hereinafter referred to as a situation recognition map) that is used to recognize the situation in the surroundings of the host car, as necessary. The situation recognition map is, for example, an occupancy grid map.

The situation of the host car to be recognized includes, for example, the position, attitude, and movement (e.g., speed, acceleration, moving direction, and the like) of the host car, the presence/absence and contents of abnormality, and the like. The situation in the surroundings of the host car to be recognized includes, for example, the types and positions of stationary objects in the surroundings, the types, positions, and movement (e.g., speed, acceleration, moving direction, and the like) of moving objects in the surroundings, road structure and road surface conditions in the surroundings, the weather, temperature, humidity, and brightness in the surroundings, and the like. The state of the driver to be recognized includes, for example, physical conditions, the arousal level, the concentration level, the fatigue level, movement of the line of sight, driving operation, and the like.

The situation recognition section 153 supplies data indicating the recognition process result (including the situation recognition map, as necessary) to the self-position estimation section 132, the situation prediction section 154, and the like. Further, the situation recognition section 153 causes the storage section 111 to store the situation recognition map.

The situation prediction section 154 performs a process of predicting the situation related to the host car on the basis of data or signals from each section of the vehicle control system 100 such as the map analysis section 151, the traffic rule recognition section 152, and the situation recognition section 153. For example, the situation prediction section 154 performs a process of predicting the situation of the host car, the situation in the surroundings of the host car, the situation of the driver, and the like.

The situation of the host car to be predicted includes, for example, the behavior of the host car, the occurrence of abnormality, a mileage, and the like. The situation in the surroundings of the host car to be predicted includes, for example, the behavior of moving objects in the surroundings of the host car, a change in the state of a traffic light, a change in the environment such as weather, and the like. The situation of the driver to be predicted includes, for example, the behavior, physical conditions, and the like of the driver.

The situation prediction section 154 supplies data indicating the prediction process result, together with data from the traffic rule recognition section 152 and the situation recognition section 153, to the route planning section 161, the action planning section 162, and the operation planning section 163 of the planning section 134, and the like.

The route planning section 161 plans a route to a destination on the basis of data or signals from each section of the vehicle control system 100 such as the map analysis section 151 and the situation prediction section 154. For example, the route planning section 161 sets a route from the current position to a specified destination on the basis of the global map. Further, for example, the route planning section 161 appropriately changes the route on the basis of situations of traffic congestion, accidents, traffic regulations, construction, and the like, physical conditions of the driver, and the like. The route planning section 161 supplies data indicating the planned route to the action planning section 162 and the like.

The action planning section 162 plans action of the host car for safely traveling the route planned by the route planning section 161 within the planned time on the basis of data or signals from each section of the vehicle control system 100 such as the map analysis section 151 and the situation prediction section 154. For example, the action planning section 162 makes a plan for start, stop, the traveling direction (e.g., forward, backward, left turn, right turn, direction change, or the like), the traveling lane, the traveling speed, overtaking, and the like. The action planning section 162 supplies data indicating the planned action of the host car to the operation planning section 163 and the like.

The operation planning section 163 plans the operation of the host car for carrying out the action planned by the action planning section 162 on the basis of data or signals from each section of the vehicle control system 100 such as the map analysis section 151 and the situation prediction section 154. For example, the operation planning section 163 makes a plan for acceleration, deceleration, a traveling trajectory, and the like. The operation planning section 163 supplies data indicating the planned operation of the host car to an acceleration/deceleration control section 172 and a direction control section 173 of the operation control section 135, and the like.

The operation control section 135 controls the operation of the host car. The operation control section 135 includes the emergency avoidance section 171, the acceleration/deceleration control section 172, and the direction control section 173.

The emergency avoidance section 171 performs a process of detecting an emergency such as collision, contact, entry into a dangerous zone, abnormality of the driver, or abnormality of the vehicle on the basis of the detection results of the outside-vehicle information detection section 141, the in-vehicle information detection section 142, and the vehicle state detection section 143. In a case where the emergency avoidance section 171 detects the occurrence of an emergency, the emergency avoidance section 171 plans the operation of the host car such as a sudden stop or a sharp turn to avoid the emergency. The emergency avoidance section 171 supplies data indicating the planned operation of the host car to the acceleration/deceleration control section 172, the direction control section 173, and the like.

The acceleration/deceleration control section 172 performs acceleration/deceleration control for carrying out the operation of the host car planned by the operation planning section 163 or the emergency avoidance section 171. For example, the acceleration/deceleration control section 172 calculates a control target value of the drive force generation apparatus or the braking apparatus for carrying out the planned acceleration, deceleration, or sudden stop and supplies a control command indicating the calculated control target value to the drive control section 107.

The direction control section 173 performs direction control for carrying out the operation of the host car planned by the operation planning section 163 or the emergency avoidance section 171. For example, the direction control section 173 calculates a control target value of the steering mechanism for achieving the traveling trajectory or sharp turn planned by the operation planning section 163 or the emergency avoidance section 171 and supplies a control command indicating the calculated control target value to the drive control section 107.

In the vehicle control system 100 described above, the data acquisition section 102 and the detection section 131 are included in the object detection section that detects objects in the surroundings of the vehicle 200. Further, in the vehicle control system 100, the communication section 103 is included in a communication section that communicates with objects in the surroundings of the vehicle 200. Further, in the vehicle control system 100, the output section 106 is included in a display section that displays the surrounding environment. Further, in the vehicle control system 100, the output control section 105 is included in a display control section that controls display of the surrounding environment on the basis of object information regarding an object detected by the object detection section and object information included in the response signal.

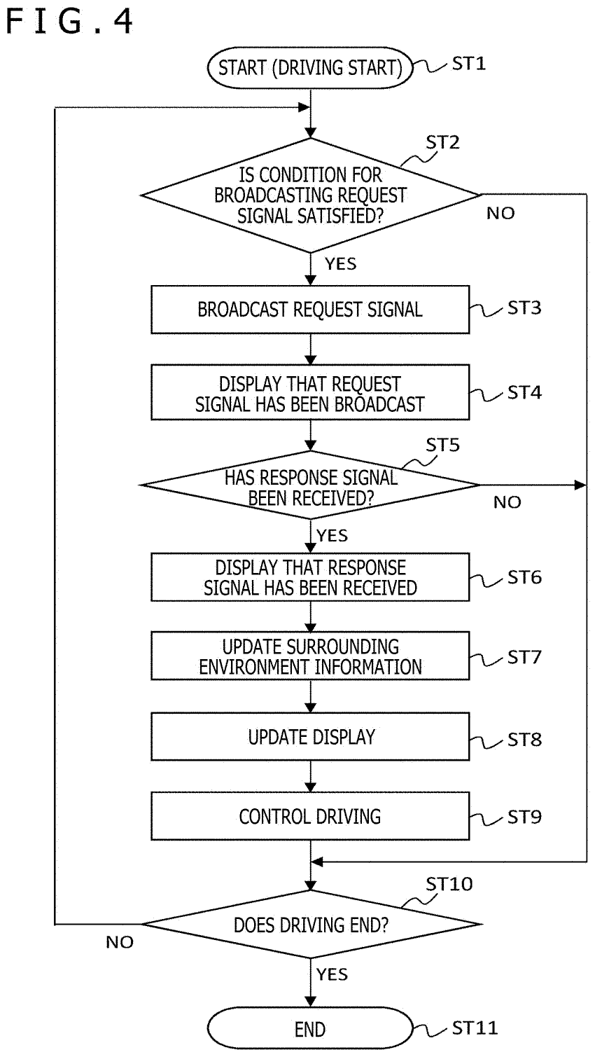

A flowchart in FIG. 4 illustrates an example of a processing procedure of the vehicle 200. In step ST1, the vehicle 200 starts processing with the start of driving. Next, in step ST2, the vehicle 200 determines whether the condition for broadcasting the request signal (radio horn) Sr, which requests information regarding an object that has not been detected by the object detection section, is satisfied.

In a case where the transmission condition is satisfied, the vehicle 200 broadcasts the request signal Sr in step ST3. Next, in step ST4, the vehicle 200 displays on the display section (e.g., the display panel of the car navigation system or the head-up display) that the request signal has been broadcast. This allows the driver to know that the request signal has been broadcast.

Next, in step ST5, the vehicle 200 determines whether the response signal Sa has been received. In a case where the vehicle 200 has received the response signal Sa, the vehicle 200 displays on the display section in step ST6 that the response signal has been received. This allows the driver to know that the response signal has been received.

Next, in step ST7, the vehicle 200 updates surrounding environment information on the basis of information regarding an object included in the response signal. Then, in step ST8, the vehicle 200 updates the display of the surrounding environment displayed on the display section. In this case, the display of the updated surrounding environment also includes the display of the object on the basis of the information regarding the object included in the response signal.

Next, in step ST9, the vehicle 200 controls driving on the basis of the information regarding the object included in the response signal. For example, in a case where the object included in the response signal is located in the direction in which the vehicle 200 travels, the vehicle 200 performs control such as deceleration or stop.

Next, the vehicle 200 proceeds to a process in step ST10. It is noted that in a case where the condition for transmitting the request signal is not satisfied in step ST2 described above or in a case where the response signal is not received in step ST5 described above, the vehicle 200 immediately proceeds to the process in step ST10. In this step ST10, the vehicle 200 determines whether driving ends. In a case where driving does not end, the vehicle 200 returns to step ST2 and performs a process similar to the process described above. On the other hand, in a case where driving ends, the vehicle 200 ends the process in step ST11.

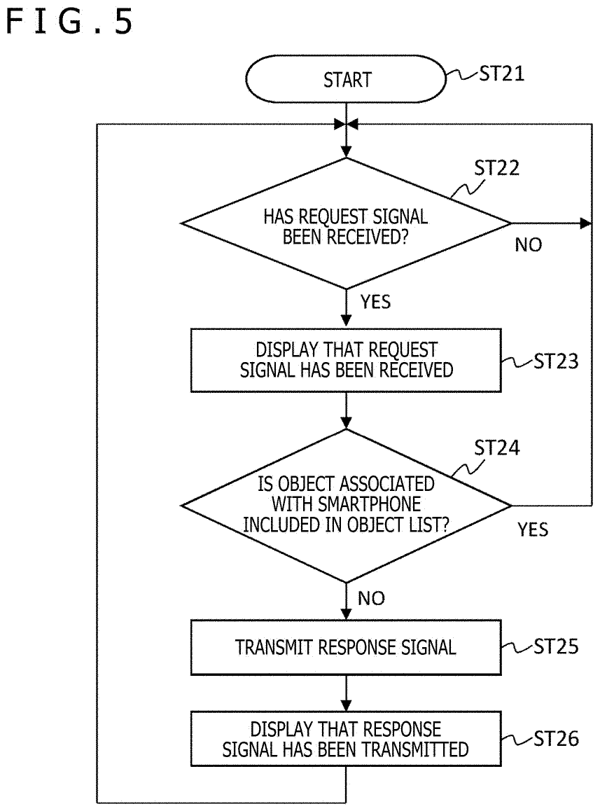

A flowchart in FIG. 5 illustrates an example of a processing procedure of the smartphone 210 (210a, 210b). In step ST21, the smartphone 210 starts processing with the power turned on. Next, in step ST22, the smartphone 210 determines whether the request signal has been received. In a case where the smartphone 210 has received the request signal, the smartphone 210 displays on the display section in step ST23 that the request signal has been received. Accordingly, the person who is the owner of the smartphone can know that the request signal has been received and, therefore, that a vehicle that has generated the request signal is present in the surroundings of the person.

Next, in step ST24, the smartphone 210 determines whether the object (person) associated with the smartphone 210 is included in the object list section of the request signal. In this case, in a case where object information having the same position and attribute as the object (person) associated with the smartphone 210 is included in the object list section, the smartphone 210 determines that the object (person) associated with the smartphone 210 is included. In a case where the object (person) associated with the smartphone 210 is included, the smartphone 210 returns to step ST22 and performs a process similar to the process described above.

In a case where the object (person) associated with the smartphone 210 is not included in step ST24, the smartphone 210 transmits (unicasts) the response signal to the vehicle 200 in step ST25. This response signal includes object information regarding the object (person) associated with the smartphone 210. Then, in step ST26, the smartphone 210 displays on the display section that the response signal has been transmitted. Accordingly, the person who is the owner of the smartphone can know that the response signal has been transmitted and, therefore, that the vehicle 200 located in the surroundings has not detected the person, and the person can exercise caution against the vehicle in the surroundings. After the process in step ST26, the smartphone 210 returns to step ST22 and performs a process similar to the process described above.

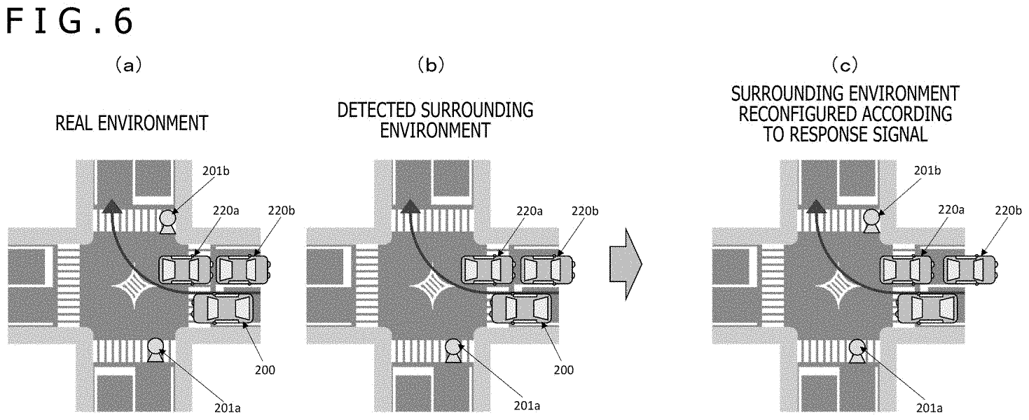

FIG. 6(a) illustrates an example of a real environment. In this case, the vehicle 200 enters the intersection and uses a right turn. In this case, in the surroundings of the vehicle 200, the object (person) 201a is present at a pedestrian crossing on the left side and the object (person) 201b is present at a pedestrian crossing on the right side. Objects (vehicles) 220a and 220b are present in the opposite lane on the right side.

FIG. 6(b) illustrates an example of display of the surrounding environment on the basis of the detection by the object detection section of the vehicle 200. In this case, the object (person) 201a and the objects (vehicles) 220a and 220b are detected by the object detection section of the vehicle 200, while the object (person) 201b is not detected. In this case, since the vehicle 200 enters the intersection and thus satisfies the condition for broadcasting the request signal, the vehicle 200 broadcasts the request signal including object information regarding these detected objects.

FIG. 6(c) illustrates an example of display of the surrounding environment reconfigured after reception of the response signal. In this case, the response signal is transmitted (unicast) to the vehicle 200 from the smartphone 210b associated with the object (person) 201b. Since the response signal includes object information regarding the object (person) 201b, the object (person) 201b is also displayed in the example of the display of the reconfigured surrounding environment, and the surrounding environment is correctly displayed.

As described above, the vehicle 200 illustrated in FIG. 1 broadcasts the request signal requesting information regarding an object that has not been detected by the object detection section and receives the response signal including the information regarding the object. Therefore, the accuracy of recognizing objects that are present in the surroundings of the vehicle 200 can be increased.

Further, a terminal such as a smartphone associated with an object that is present in the surroundings of the vehicle 200 illustrated in FIG. 1 unicasts information regarding the object to the vehicle 200 in a case where the information regarding the object associated with the terminal is not included in the request signal received from the vehicle 200. Therefore, the vehicle 200 can increase the accuracy of recognizing objects that are present in the surroundings.

<2. Modification>It is noted that the effects described in the present specification are merely examples and are not limited, and additional effects that are not described may be provided. Further, the present technology should not be construed as limited to the embodiment of the technology described above. The embodiment of the technology discloses the present technology in the form of examples, and it is obvious that those skilled in the art can make modifications or substitutions of the embodiment without departing from the scope of the present technology. That is, claims should be taken into consideration to determine the scope of the present technology.

Further, the present technology can also have the following configurations.

(1) An information processing apparatus including:

an object detection section configured to detect an object that is present in surroundings;

a transmission section configured to broadcast a request signal requesting information regarding an object that has not been detected by the object detection section; and

a reception section configured to receive a response signal in response to transmission of the request signal, the response signal including the information regarding the object that has not been detected by the object detection section.

(2) The information processing apparatus according to (1), in which the transmission section broadcasts the request signal in a driving caution area.

(3) The information processing apparatus according to (1) or (2), in which the transmission section broadcasts the request signal in a place with poor visibility.

(4) The information processing apparatus according to any one of (1) to (3), in which the transmission section broadcasts the request signal in a case where there is a possibility that an object enters in a traveling direction.

(5) The information processing apparatus according to any one of (1) to (4), in which the request signal includes information regarding a predetermined number of objects detected by the object detection section.

(6) The information processing apparatus according to any one of (1) to (5), further including:

a display control section configured to control display of a surrounding environment on the basis of information regarding positions and attributes of a predetermined number of objects detected by the object detection section and control update of the display of the surrounding environment on the basis of information regarding a position and an attribute of the object that is included in the response signal and that has not been detected by the object detection section.

(7) The information processing apparatus according to any one of (1) to (6), in which in a case where the object that is included in the response signal and that has not been detected by the object detection section is located in a direction in which a host vehicle travels, the transmission section transmits a caution signal for calling for caution to a transmitter of the response signal.

(8) An information processing method including:

an object detection step of detecting, by an object detection section, an object that is present in surroundings;

a transmission step of broadcasting, by a transmission section, a request signal requesting information regarding an object that has not been detected in the object detection step; and

a reception step of receiving, by a reception section, a response signal in response to transmission of the request signal, the response signal including the information regarding the object that has not been detected in the object detection step.

(9) An information processing apparatus including:

a reception section configured to receive a request signal from external equipment, the request signal including information regarding positions and attributes of a predetermined number of objects that are present in surroundings of the external equipment; and

a transmission section configured to, in a case where a predetermined object associated with the information processing apparatus is not included in the predetermined number of objects, unicast a response signal including information regarding a position and an attribute of the predetermined object to the external equipment.

(10) An information processing method including:

a reception step of receiving, by a reception section, a request signal from external equipment, the request signal including information regarding positions and attributes of a predetermined number of objects that are present in surroundings of the external equipment; and

a transmission step of, in a case where a predetermined object associated with an information processing apparatus is not included in the predetermined number of objects, unicasting, by a transmission section, a response signal including information regarding a position and an attribute of the predetermined object to the external equipment.

### REFERENCE SIGNS LIST

100 Vehicle control system

200 Vehicle

201a, 201b Object (person)

210a, 210b Smartphone

220a, 220b Object (vehicle)

1. An information processing apparatus comprising:
an object detection section configured to detect an object that is present in surroundings;
a transmission section configured to broadcast a request signal requesting information regarding an object that has not been detected by the object detection section; and
a reception section configured to receive a response signal in response to transmission of the request signal, the response signal including the information regarding the object that has not been detected by the object detection section.

2. The information processing apparatus according to claim 1, wherein the transmission section broadcasts the request signal in a driving caution area.

3. The information processing apparatus according to claim 1, wherein the transmission section broadcasts the request signal in a place with poor visibility.

4. The information processing apparatus according to claim 1, wherein the transmission section broadcasts the request signal in a case where there is a possibility that an object enters in a traveling direction.

5. The information processing apparatus according to claim 1, wherein the request signal includes information regarding a predetermined number of objects detected by the object detection section.

6. The information processing apparatus according to claim 1, further comprising:
a display control section configured to control display of a surrounding environment on a basis of information regarding positions and attributes of a predetermined number of objects detected by the object detection section and control update of the display of the surrounding environment on a basis of information regarding a position and an attribute of the object that is included in the response signal and that has not been detected by the object detection section.

7. The information processing apparatus according to claim 1, wherein in a case where the object that is included in the response signal and that has not been detected by the object detection section is located in a direction in which a host vehicle travels, the transmission section transmits a caution signal for calling for caution to a transmitter of the response signal.

8. An information processing method comprising:
an object detection step of detecting, by an object detection section, an object that is present in surroundings;
a transmission step of broadcasting, by a transmission section, a request signal requesting information regarding an object that has not been detected in the object detection step; and
a reception step of receiving, by a reception section, a response signal in response to transmission of the request signal, the response signal including the information regarding the object that has not been detected in the object detection step.

9. An information processing apparatus comprising:
a reception section configured to receive a request signal from external equipment, the request signal including information regarding positions and attributes of a predetermined number of objects that are present in surroundings of the external equipment; and
a transmission section configured to, in a case where a predetermined object associated with the information processing apparatus is not included in the predetermined number of objects, unicast a response signal including information regarding a position and an attribute of the predetermined object to the external equipment.

10. An information processing method comprising:
a reception step of receiving, by a reception section, a request signal from external equipment, the request signal including information regarding positions and attributes of a predetermined number of objects that are present in surroundings of the external equipment; and
a transmission step of, in a case where a predetermined object associated with an information processing apparatus is not included in the predetermined number of objects, unicasting, by a transmission section, a response signal including information regarding a position and an attribute of the predetermined object to the external equipment.
